(19) United States
(12) Patent Application Publication
(10) Pub. No.: US 2025/0284178 A1
(43) Pub. Date: Sep. 11, 2025

(54) LIGHT-AMOUNT ADJUSTING APPARATUS, LENS APPARATUS, AND IMAGE PICKUP APPARATUS

(71) Applicant: CANON KABUSHIKI KAISHA, Tokyo (JP)

(72) Inventor: KATSUHIKO SATO, Tochigi (JP)

(21) Appl. No.: 19/066,570

(22) Filed: Feb. 28, 2025

(30) Foreign Application Priority Data
Mar. 8, 2024 (JP) 2024-035996

(51) Int. Cl. G03B 9/06; G03B 35/08; H04N 13/239; H04N 23/55; H04N 23/75

(52) U.S. Cl. CPC G03B 9/06; G03B 35/08; H04N 13/239; H04N 23/55; H04N 23/75

(57) ABSTRACT

A light-amount adjusting apparatus includes a drive unit configured to drive blade members, a first opening/closing unit including three or more blade members to open and close at least a part of a first opening according to driving of the drive unit, and a second opening/closing unit including blade members as many as the blade members constituting the first opening/closing unit to open and close at least a part of a second opening according to driving of the drive unit. The first and second opening/closing unit are arranged so that in a case where images obtained by imaging using the first optical system and the second optical system are superimposed and all angles between adjacent light striations generated when the light passes through apertures formed by the first opening/closing unit and the second opening/closing unit are equal angles, all the angles between adjacent light striations fall within ±5 degrees.

### BACKGROUND

### Technical Field

The present disclosure relates to a light-amount adjusting apparatus having a compound-eyes optical system.

### Description of Related Art

Stereoscopic image pickup apparatuses and VR video capture apparatuses that perform imaging using a compound-eyes optical system including a plurality of optical systems have conventionally been known. Japanese Patent Laid-Open No. 2014-119615 discloses a light-amount adjusting apparatus configured to adjust a light amount of each optical system by opening and closing a plurality of blade members.

In the light-amount adjusting apparatus disclosed in Japanese Patent Laid-Open No. 2014-119615, the number of blade members is one or two for each opening, so the obtained blur shape is a polygonal shape with a small number of sides.

### SUMMARY

A light-amount adjusting apparatus according to one aspect of the disclosure is configured to adjust a light amount of a first optical system and a light amount of a second optical system. The light-amount adjusting apparatus includes a drive unit configured to drive blade members, a first opening/closing unit including three or more blade members and configured to open and close at least a part of a first opening through which light is to pass, according to driving of the drive unit, and a second opening/closing unit including blade members as many as the blade members constituting the first opening/closing unit and configured to open and close at least a part of a second opening through which light is to pass, according to driving of the drive unit. The first opening/closing unit and the second opening/closing unit are arranged so that in a case where images obtained by imaging using the first optical system and the second optical system are superimposed and all angles between adjacent light striations generated when the light passes through apertures formed by the first opening/closing unit and the second opening/closing unit are equal angles, all the angles between adjacent light striations fall within ±5 degrees. A lens apparatus and an image pickup apparatus each having the above light-amount adjusting apparatus also constitute another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of an image pickup apparatus according to a first embodiment.

FIG. 2 is a perspective view of a light-amount adjusting apparatus according to the first embodiment.

FIG. 3 is an exploded perspective view of the light-amount adjusting apparatus according to the first embodiment.

FIGS. 4A and 4B explain a rotating direction of a blade drive member and the phase of the blade members in the light-amount adjusting apparatus according to the first embodiment.

FIGS. 5A and 5B explain the generation principle of a light striation.

FIG. 6 illustrates light striations.

FIGS. 7A and 7B explain a difference in the state of light striations according to a shape of an aperture.

FIGS. 8A and 8B explain light striations generated in a compound-eyes optical system unit according to the first embodiment.

FIGS. 9A and 9B illustrate example light striations generated in a case where a shape of an aperture in a second embodiment is an odd polygon.

FIGS. 10A and 10B illustrate example light striations generated in a case where a shape of an aperture in the second embodiment is an even polygon.

FIGS. 11A and 11B illustrate other examples of light striations generated in a case where a shape of an aperture in the second embodiment is an odd polygon.

FIGS. 12A and 12B explain the configuration of a light-amount adjusting apparatus according to a third embodiment.

FIGS. 13A and 13B explain the configuration of a light-amount adjusting apparatus according to a fourth embodiment.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

### First Embodiment

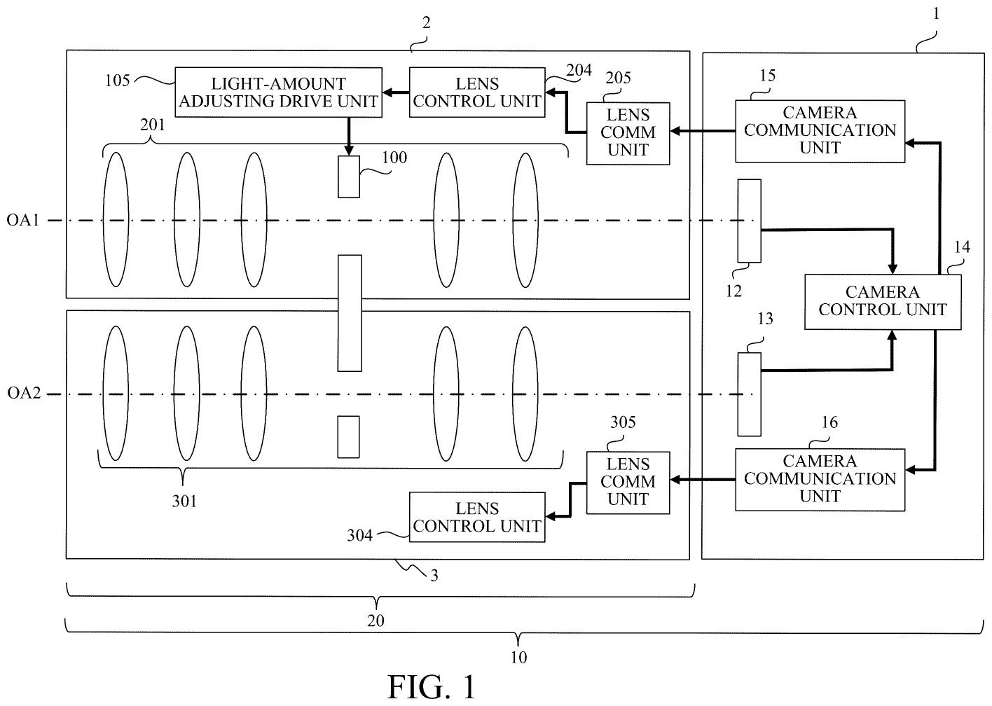

FIG. 1 is a block diagram of an image pickup apparatus 10 according to this embodiment. The image pickup apparatus 10 includes a camera body 1 and a compound-eyes optical system (lens apparatus) 20 including a first optical system 2 and a second optical system 3. The compound-eyes optical system unit 20 may be fixed to the camera body 1, or may be attachable to and detachable from the camera body 1 like an interchangeable lens.

The first optical system 2 and the second optical system 3 include imaging optical systems 201 and 301 including lens units that determine a focal length and focus state and have the same configurations. Each of the imaging optical systems 201 and 301 includes a light-amount adjusting apparatus 100. The imaging optical systems 201 and 301 may include a single lens or a set of multiple lenses that integrally move in adjusting the focal length and focus position.

The light-amount adjusting apparatus 100 includes a plurality of blade members (not illustrated) and an opening/closing mechanism (not illustrated) that opens and closes the plurality of blade members, and adjusts a light amount of each optical system. The opening/closing mechanism in the light-amount adjusting apparatus 100 is driven by a light-amount adjusting drive unit (drive unit) 105. The light-amount adjusting apparatus 100 is a so-called iris diaphragm in which the plurality of blade members arranged around the optical axis partially overlap each other to form an aperture (diaphragm aperture) on the optical axis. In this embodiment, since each of the first optical system 2 and the second optical system 3 has the optical axis, the optical axis of the first optical system 2 will be referred to as OA, and the optical axis of the second optical system 3 will be referred to as OB.

An aperture value (F-number) increases or decreases according to the positions of the plurality of blade members. An overlap amount of the plurality of blade members also changes according to the positions of the plurality of blade members, and the operating load applied to the light-amount adjusting drive unit 105 changes accordingly. In general, the operating load increases as the aperture value, i.e., the overlap amount of the plurality of blade members, increases.

The light-amount adjusting drive unit 105 is configured with a stepping motor and is controlled by one of lens control units 204 and 304 provided in the first optical system 2 and the second optical system 3, respectively. More specifically, one of the lens control units 204 and 304 controls a drive direction of the light-amount adjusting drive unit 105 by changing the polarity of a drive signal applied to the light-amount adjusting drive unit 105, and controls a drive position of the light-amount adjusting drive unit 105 by increasing or decreasing the number of pulses of the drive signal. Thereby, an opening and closing operation amount (aperture amount, aperture diameter) of the plurality of blade members in the light-amount adjusting apparatus 100 can be controlled. The light-amount adjusting drive unit 105 may be provided with an aperture position detector (not illustrated) configured to detect the positions of the plurality of blade members corresponding to the maximum aperture.

The lens control units 204 and 304 control the aperture amount (aperture diameter) of the light-amount adjusting apparatus 100 based on a signal (target aperture-value signal) received from the camera body 1 via lens communication (COMM) units 205 and 305. The lens control units 204 and 304 also control the aperture diameter of the light-amount adjusting apparatus 100 based on a drive instruction control amount corresponding to the luminance (aperture value).

The camera body 1 includes a first image sensor 12, a second image sensor 13, a camera control unit 14, and camera communication units 15 and 16. Each of the first and second image sensors 12 and 13 include a CMOS sensor or a CCD sensor, and performs photoelectric conversion for an optical image (object image) formed via a corresponding one of the first optical system 2 and the second optical system 3 to output image data. In this embodiment, an image sensor is provided for each imaging optical system, but a single image sensor may be configured to output a plurality of image data.

The camera control unit 14 controls the first image sensor 12, the second image sensor 13, and the camera communication units 15 and 16. The camera control unit 14 transmits information on the target aperture value of the light-amount adjusting apparatus 100 to the lens control units 204 and 304 via the camera communication units 15 and 16 and the lens communication units 205 and 305.

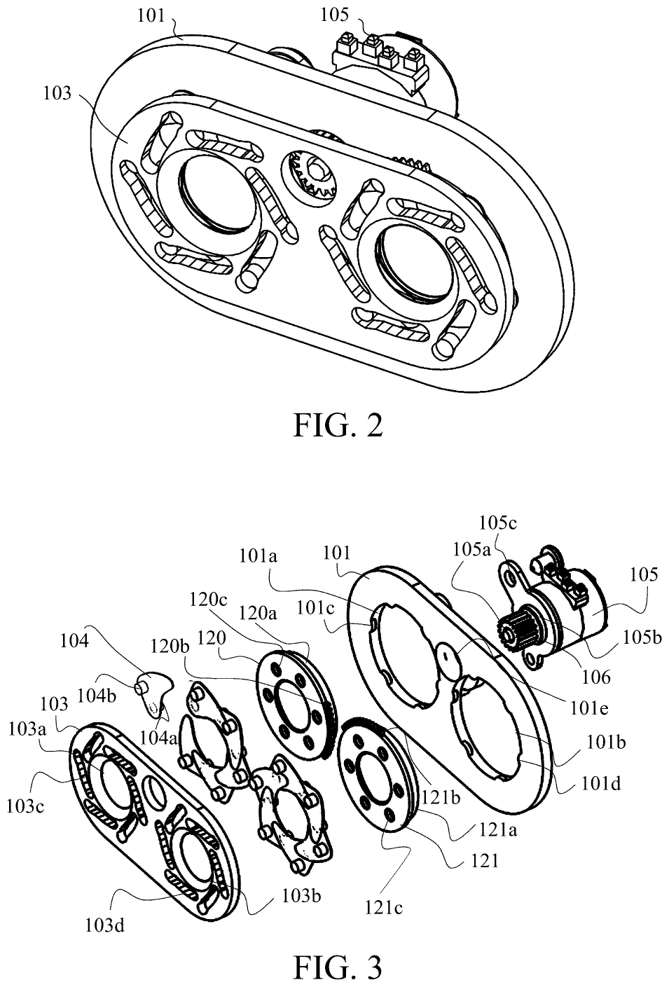

FIG. 2 is a perspective view of the light-amount adjusting apparatus 100. FIG. 3 is an exploded perspective view of the light-amount adjusting apparatus 100. The light-amount adjusting apparatus 100 includes an aperture base plate (base member) 101, a first aperture drive member (first drive member) 120, a second aperture drive ring (second drive member) 121, a cam plate (press member) 103, a plurality of blade members 104, and a light-amount adjusting drive unit 105.

The aperture base plate 101 includes a first opening 101a that has a center on the optical axis OA of the first optical system 2, and a second opening 101b that has a center on the optical axis OB of the second optical system 3. In the first opening 101a, a plurality of engagement receivers 101c for holding engagement diameter portions 120a provided on the first aperture drive ring 120 are evenly arranged along the circumferential direction. The first aperture drive ring 120 is rotatably engaged with (inserted or fitted into) the first opening 101a. In the second opening 101b, a plurality of engagement receivers 101d for holding engagement diameter portions 121a provided on the second aperture drive ring 121 are evenly arranged along the circumferential direction. The second aperture drive ring 121 is rotatably engaged with (inserted or fitted into) the second opening 101b. The aperture base plate 101 has a bearing reference hole 101e provided at a predetermined position with respect to the central axis. A bearing 105b coaxially and rotatably supports a rotational drive shaft 105a of the light-amount adjusting drive unit 105. The bearing 105b is inserted into the bearing reference hole 101e, and the fixed portion 105c provided on the light-amount adjusting drive unit 105 is fixed to the aperture base plate 101 with a screw or the like, so that the rotational drive shaft 105a is disposed at a predetermined position.

A pinion gear (transmission member) 106 is fixed to the rotational drive shaft 105a. A first ring gear (first transmitter) 120b is provided on the circumference of the first aperture drive ring 120, which is engaged (or geared) with the pinion gear 106 and rotates the first aperture drive ring 120 by receiving the rotational drive force of the light-amount adjusting drive unit 105. A second ring gear (second transmitter) 121b is provided on the circumference of the second aperture drive ring 121, which is engaged (or geared) with the pinion gear 106 and rotates the second aperture drive ring 121 by receiving the rotational drive force of the light-amount adjusting drive unit 105. Each of the first and second aperture drive rings 120 and 121 rotates in association with the rotational drive of the pinion gear 106, with the central axis coinciding with the optical axis OA and OB as the rotation center. In this embodiment, a single drive unit is provided to drive the first and second aperture drive rings 120 and 121, but two drive units may be provided to drive the first and second aperture drive rings 120 and 121, respectively.

The cam plate 103 is supported by the aperture base plate 101 while an operating space is secured for the plurality of blade members 104 and the first and second aperture drive rings 120 and 121. The cam plate 103 is provided with a first hole portion 103a that opens coaxially with the first opening 101a, and a second hole portion 103b that opens coaxially with the second opening 101b.

The blade members 104 are common parts that are equally provided in number (three or more) along the circumferential direction around the respective rotation axis centers of the first and second aperture drive rings 120 and 121. The blade members 104 that are arranged along the circumferential direction of the first aperture drive ring 120 function as the first opening/closing unit that opens and closes at least a portion of the first opening 101a according to the drive of the light-amount adjusting drive unit 105. The blade members 104 that are arranged along the circumferential direction of the second aperture drive ring 121 function as the second opening/closing unit that opens and closes at least a part of the second opening 101b according to the drive of the light-amount adjusting drive unit 105. The first and second aperture drive rings 120 and 121 and the plurality of blade members 104 are housed between the aperture base plate 101 and the cam plate 103. The blade members 104 are provided with a rotation pin (first engagement member) 104a that serves as the center of rotation and a cam pin (second engagement member) 104b that rotates the blade members 104. The rotation pin 104a and the cam pin 104b may have a hole shape.

The first aperture drive ring 120 has rotating holes 120c into which the rotation pins 104a are inserted (or engaged), and the rotating holes 120c are evenly provided along the circumferential direction. The second aperture drive ring 121 has rotating holes 121c into which the rotation pins 104a are inserted, and the rotating holes 121c are evenly provided along the circumferential direction. Each blade member 104 is supported rotatably about the rotation pins 104a.

The cam plate 103 has cam grooves (cam shape) 103c with which the cam pins 104b are engaged, which are evenly provided along the circumferential direction and coaxial with the central axis of the first hole portion 103a. As the first aperture drive ring 120 rotates, the cam pins 104b rotate the blade members 104 around the rotation pins 104a along the cam grooves 103c.

The cam plate 103 also has cam grooves (cam shape) 103d with which the cam pins 104b are engaged, which are evenly provided along the circumferential direction and coaxial with the central axis of the second hole portion 103b. As the second aperture drive ring 121 rotates, the cam pins 104b rotate the blade members 104 around the rotation pins 104a along the cam grooves 103d.

Since the plurality of blade members 104 are evenly arranged along the circumferential direction and have the same support structure, the light amount can be adjusted by setting a desired aperture diameter centered on the optical axis of each optical system by rotating the first and second aperture drive rings 120 and 121. The aperture diameter is adjusted by rotating the blade members 104 by changing a relative phase between the first and second aperture drive rings 120 and 121 and the cam plate 103.

In this embodiment, the first and second aperture drive rings 120 and 121 are provided with hole shapes with which the rotation pins 104a are engaged, and the cam plate 103 is provided with hole shapes (cam grooves) with which the cam pins 104b are engaged. However, other configurations may be used as long as the blade members 104 rotate by rotating the first and second aperture drive rings 120 and 121 to adjust the light amount. For example, the first and second aperture drive rings 120 and 121 may have hole shapes (cam grooves) with which the cam pins 104b are engaged, and the cam plate 103 may have hole shapes with which the rotation pins 104a are engaged. That is, it is sufficient that one of the first and second aperture drive rings 120 and 121 and the cam plate 103 may have hole shapes with which the rotation pins 104a are engaged, and the other may have hole shapes (cam grooves) with which the cam pins 104b are engaged. Also, the aperture base plate 101 may have hole shapes with which the rotation pins 104a are engaged, and the first and second aperture drive rings 120 and 121 may have hole shapes with which the cam pins 104b are engaged. Even in this case, it is sufficient that a gap that allows the blade members 104 to rotate may be formed on the opposite side of the first and second aperture drive rings 120 and 121, with respect to the blade members 104.

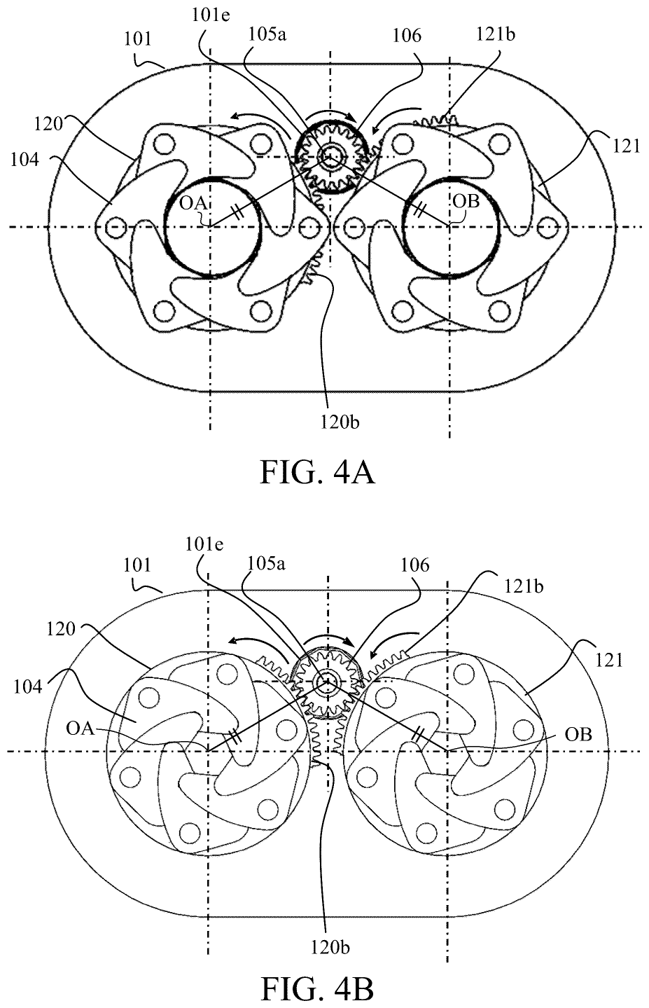

FIGS. 4A and 4B explain the rotating directions of the first and second aperture drive rings 120 and 121 and the phase of the blade members 104. FIG. 4A illustrates the light-amount adjusting apparatus 100 in the maximum aperture state, and FIG. 4B illustrates the positions of the rotation pins 104a relative to the horizontal direction in this embodiment.

The optical axis OA, which is the central axis of the first opening 101a, and the optical axis OB, which is the central axis of the second opening 101b, are arranged at a 1:1 distance from the central axis of the bearing reference hole 101e that holds the light-amount adjusting drive unit 105. The pinion gear 106 is engaged with the first and second ring gears 120b and 121b at the same reduction ratio, and the first and second aperture drive rings 120 and 121 can rotate by the same angle in the same rotating direction due to the rotation of the light-amount adjusting drive unit 105. Thereby, in the first and second optical systems 2 and 3, the aperture diameters of the optical systems change in synchronization due to the rotation of the light-amount adjusting drive unit 105, and the light amount can be adjusted.

There are as many blade members 104 arranged evenly around the optical axis OA, which is the central axis of the first opening 101a, as there are blade members 104 arranged around the optical axis OB, which is the central axis of the second opening 101b. The phases of the blade members 104 arranged around the respective optical axes are approximately equal. In this embodiment, six blade members 104 are arranged for each optical system, but the number of blade members 104 is not limited to six.

As illustrated in FIG. 4B, the aperture formed by the blade members 104 has a polygonal shape. The phases of the blade members 104 arranged around the respective optical axes are equal. In other words, the phases of the corresponding blade members 104 are the same. Therefore, the angular phases of the polygons formed in the narrowed state are also equal. Thus, the phases (positions in the direction around the optical axis) of the light striations generated when light passes through each optical system are the same. Thereby, in a case where captured images are superimposed and checked using a VR video capture apparatus or the like, the phase shifts of the light striations are the same, and an image that does not provide the unnatural feeling can be obtained. Here, “equal” and “same phase” may be strictly or substantially (approximately) equal or the same phase. A distance between light striations (angle between phases) may have a shift (angle shift, phase shift) of less than 5 degrees from a designed value. That is, the first opening/closing unit and the second opening/closing unit may be arranged so that in a case where images obtained by imaging using the first optical system and the second optical system are superimposed and all angles between adjacent light striations generated when the light passes through apertures formed by the first opening/closing unit and the second opening/closing unit are equal angles, all the angles between adjacent light striations fall within ±5 degrees.

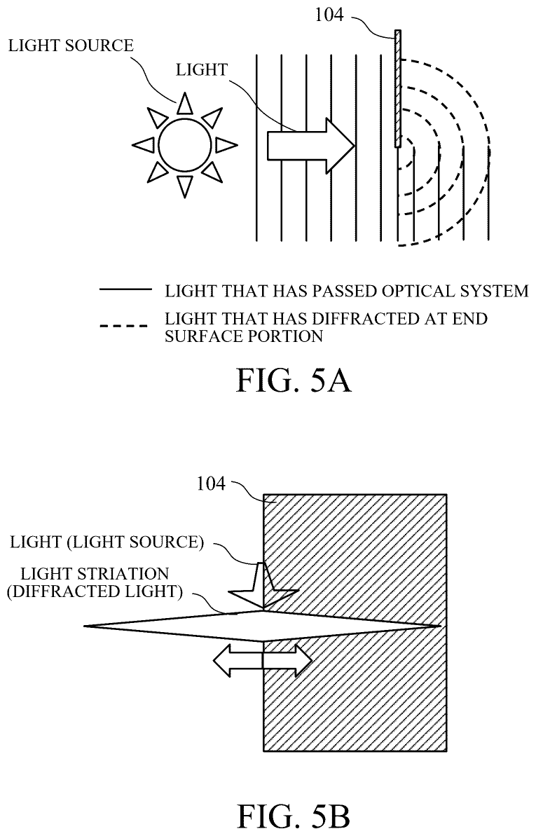

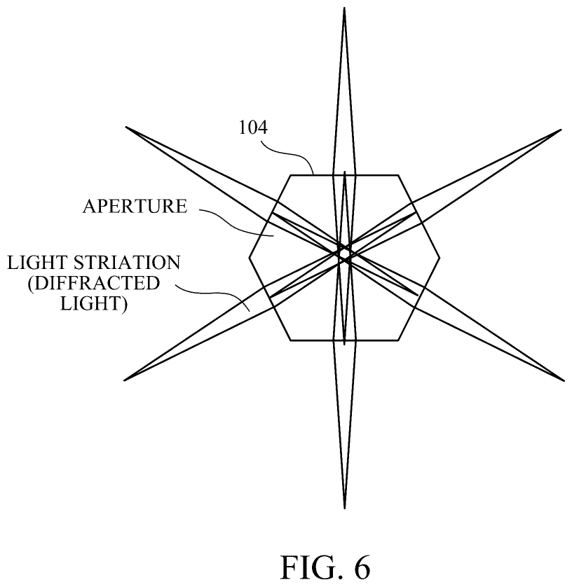

FIGS. 5A and 5B explain the generation principle of light striations generated in a case where light passes through an optical system. FIG. 6 illustrates light striations. FIG. 5A illustrates the state in which light from a light source passes through the blade members 104. FIG. 5B illustrates a light striation generated when the light passes through the blade members 104 and light is irradiated onto the end surface portion of the aperture formed by the blade members 104. Part of the light that passes through the optical system, as illustrated by a solid line in FIG. 5A, is shielded by the blade members 104, and the other part passes through the aperture. Of the light that passes through the aperture, the light diffracted at the end surface portion of the aperture spreads, wrapping around behind the blade member 104, as illustrated by a dashed line. The light diffracted at the end surface portion spreads in a band shape outside and inside the end surface portion, as illustrated in FIG. 5B. Thereby, a phenomenon called light striations occurs, as illustrated in FIG. 6.

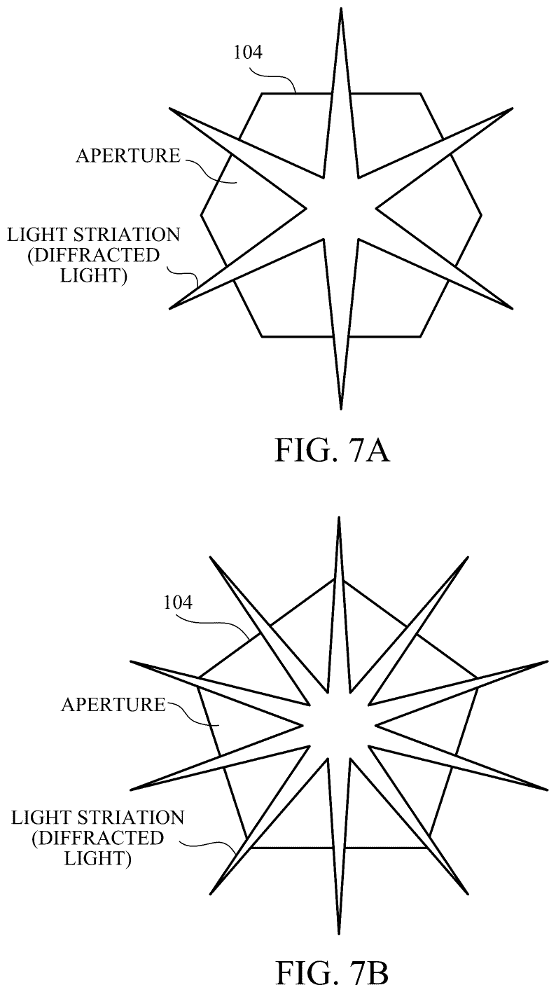

FIGS. 7A and 7B explain a difference in light striation due to the shape of the aperture. FIG. 7A illustrates a schematic diagram of light striations in a case where the shape of the aperture is an even polygon with an even number of sides. FIG. 7B illustrates a schematic diagram of light striations in a case where the shape of the aperture is an odd polygon with an odd number of sides.

In a case where the shape of the aperture is an even polygon, there are end surface portions facing each other on opposite sides of the optical axis, so the light striations generated at the opposing end faces overlap each other and appear to be a single light striation. In this case, the number of light striations generated is the same as the number of sides of the polygon. In FIG. 7A, the shape of the aperture is hexagonal, so six light rays appear to be radiating from the optical axis.

In a case where the shape of the aperture is an odd polygon, there are no end surfaces facing each other across the optical axis, so twice as many light rays appear to be generated as there are end surface portions. In FIG. 7B, the shape of the aperture is pentagonal, so ten light rays appear to be radiating from the optical axis.

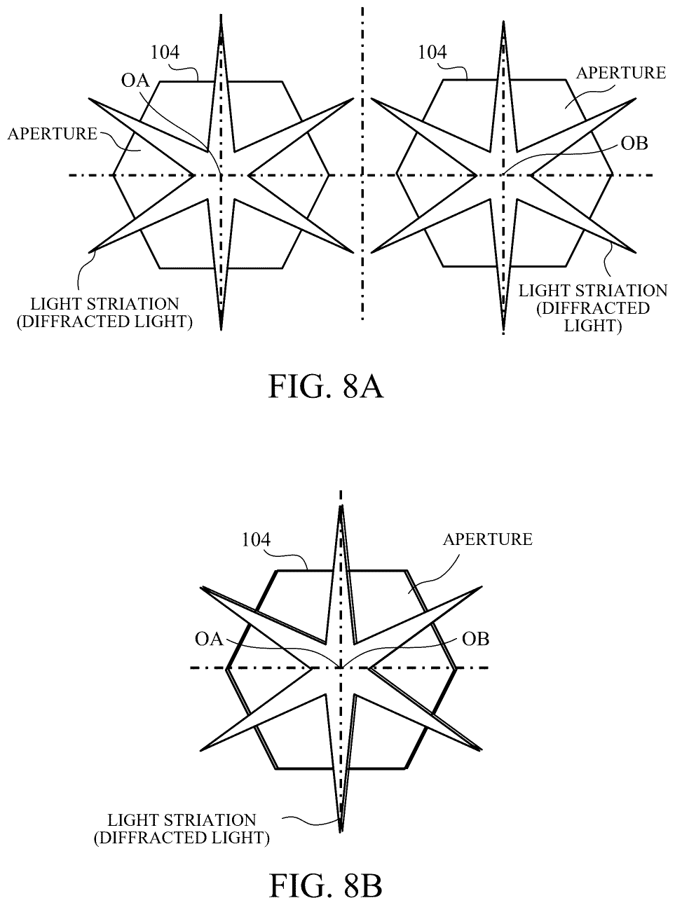

FIGS. 8A and 8B explain light striations generated in the compound-eyes optical system unit 20 according to the first embodiment. FIG. 8A illustrates light striations generated in each optical system. As illustrated in FIG. 8A, in this embodiment, the light striations generated in each optical system have the same phase. Here, “same” may be strictly or substantially (approximately) the same. FIG. 8B illustrates how the light striations illustrated in FIG. 8A appear in a case where the captured images are superimposed and confirmed using a VR video capture apparatus or the like. As illustrated in FIG. 8B, the light striations generated in the same phase are expressed as almost overlapping.

As described above, the configuration according to this embodiment can achieve a natural captured image while a good blur effect is obtained.

### Second Embodiment

In the first embodiment, the phases of the blade members 104 arranged for the respective optical systems are the same. However, even if the light striations generated in the respective optical systems are not in the same phase, if the light striations are generated at regular intervals, an image that does not look unnatural can be obtained when the captured images are superimposed and confirmed using a VR video capture apparatus or the like. Regular intervals may be strictly or substantially (approximately) regular intervals.

This embodiment will discuss a description of how the phases of the blade members 104 arranged for the respective optical systems are shifted to make the intervals between the light striations regular. This embodiment will discuss only the configuration that is different from that of the first embodiment, and will omit a description of the common configuration.

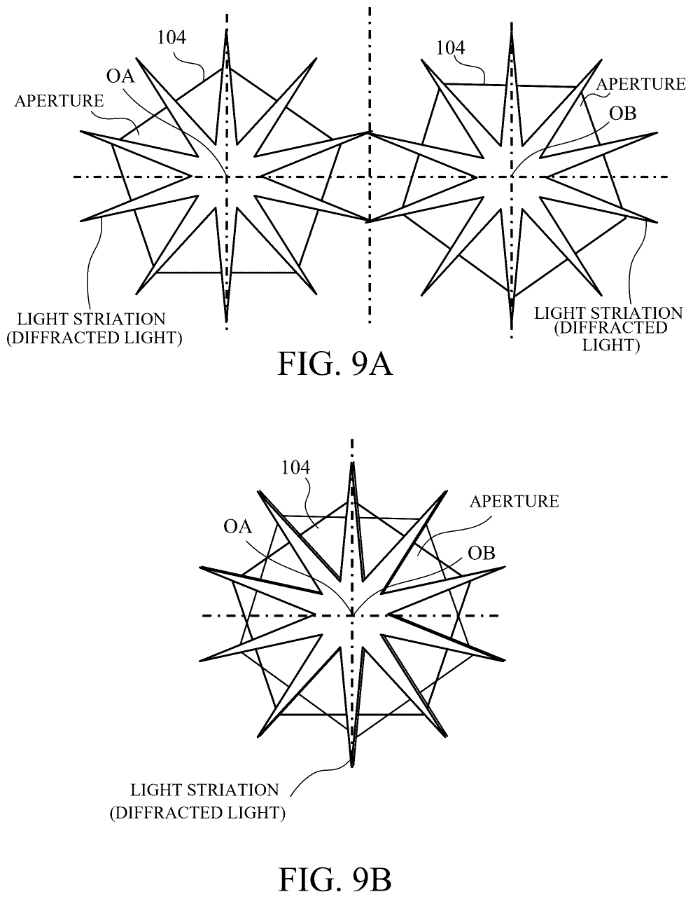

FIGS. 9A and 9B illustrate example light striations generated in a case where the shape of the aperture is an odd polygon. FIG. 9A illustrates light striations generated in the respective optical systems. In a case where the shape of the aperture is an odd polygon, even if the phase of the aperture is shifted, the phases of the generated light striations are the same as long as the phase shift angle [degrees] of the blade members 104 has a value calculated by the following equation (1) where m is a positive integer:

Phase shift angle=(360×m)/(number of blade members 104×2) (1)

FIG. 9A illustrates the shape of the aperture and the light striations in a case where the shape of the aperture is pentagonal and the phase shift angle is 36 degrees. FIG. 9B illustrates how the light striations in FIG. 9A appear in a case where the captured images are superimposed and confirmed using a VR video capture apparatus or the like. As illustrated in FIG. 9B, the phases of the light striations generated in the same phase are expressed as almost overlapping.

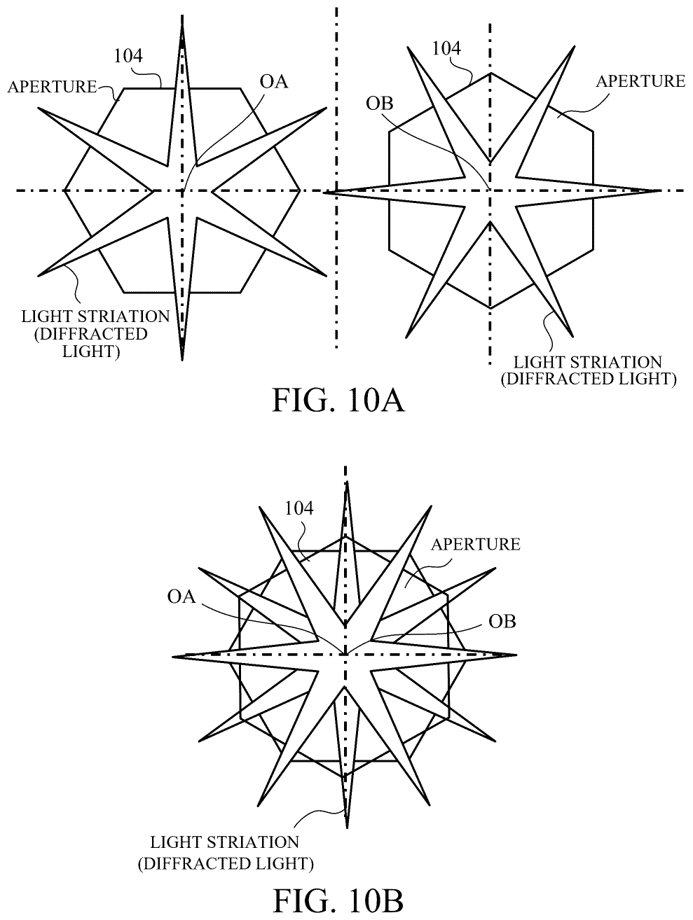

FIGS. 10A and 10B illustrate example light striations generated in a case where the shape of the aperture is an even polygon. FIG. 10A illustrates light striations in a case where the shape of the aperture is hexagonal and the phase shift angle is 30 degrees. FIG. 10B illustrates how the light striations in FIG. 10A appear in a case where the captured images are superimposed and confirmed using a VR video capture apparatus or the like. As illustrated in FIG. 10B, the light striations are expressed as overlapping so that they are generated at regular intervals.

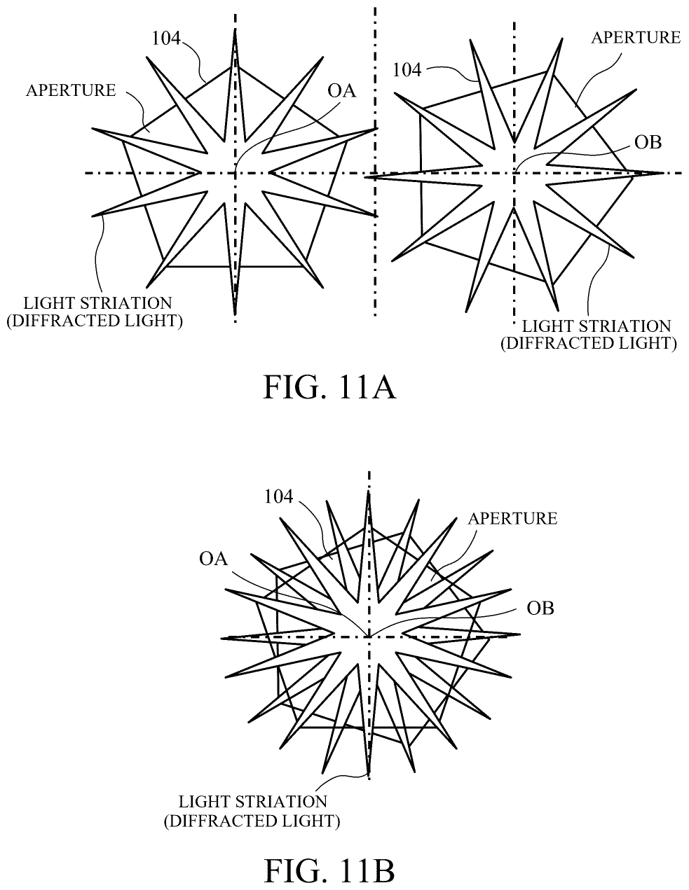

FIGS. 11A and 11B illustrate other example light striations that occur in a case where the shape of the aperture is an odd polygon. FIG. 11A illustrates light striations generated in the respective optical systems in a case where the phase shift angle [degrees] of the blade members 104 has a value calculated by the following equation (2) where m is a positive integer:

Phase shift angle=(360×m)/(number of blade members 104×4) (2)

In FIG. 11A, the shape of the aperture is a pentagon, and the phase shift angle is 18 degrees. FIG. 11B illustrates how the light striations in FIG. 11A appear in a case where the captured images are superimposed and confirmed using a VR video capture apparatus or the like. As illustrated in FIG. 11B, the light striations are expressed as overlapping so that they are generated at regular intervals.

A distance between adjacent light striations (angle between phases) may have a shift (angle shift, phase shift) of less than 5 degrees from a designed value. That is, the first opening/closing unit and the second opening/closing unit may be arranged so that in a case where images obtained by imaging using the first optical system and the second optical system are superimposed and all angles between adjacent light striations generated when the light passes through apertures formed by the first opening/closing unit and the second opening/closing unit are equal angles, all the angles between adjacent light striations fall within ±5 degrees.

As described above, the configuration according to this embodiment can achieve a natural captured image while a good blur effect is obtained.

### Third Embodiment

In order to suppress a difference in characteristic such as a difference in aperture diameter accuracy in each optical system, the first and second aperture drive rings 120 and 121 may have the same structure. In a case where a single light-amount adjusting drive unit 105 is provided, it is difficult to align the phases of the plurality of blade members 104 because the assembly phases of the first and second ring gears 120b and 121b relative to the pinion gear 106 are different. This embodiment will discuss a configuration for solving such problems. This embodiment will discuss only the configuration that is different from that of the first embodiment, and will omit the common configuration.

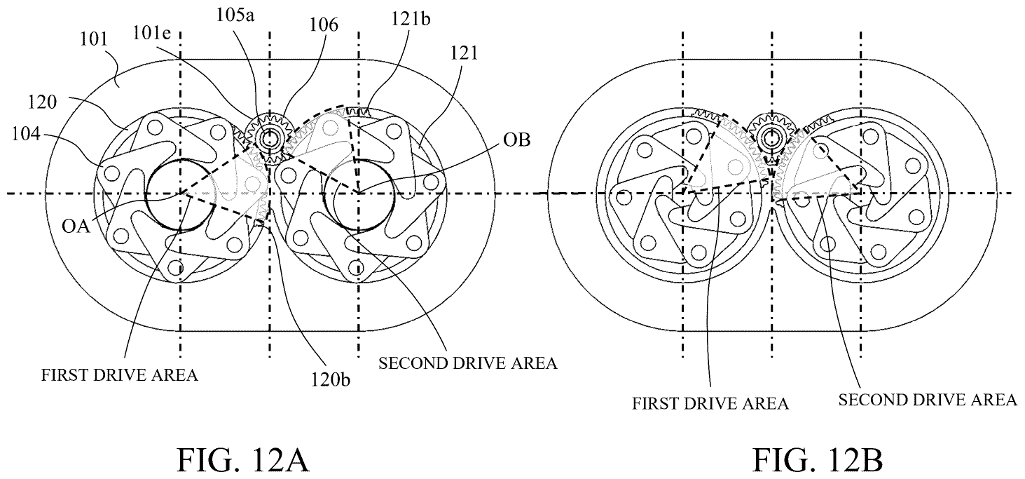

FIGS. 12A and 12B explain the configuration of the light-amount adjusting apparatus 100 according to this embodiment. FIG. 12A illustrates the light-amount adjusting apparatus 100 in a maximum aperture state, and FIG. 12B illustrates the light-amount adjusting apparatus 100 in a closed state. The first and second aperture drive rings 120 and 121 have the same structure. The first and second ring gears 120b and 121b provided on the first and second aperture drive rings 120 and 121 have gear teeth (cogs) formed in a range wider than an engagement (or geared) range with the pinion gear 106 required from the maximum aperture to a small aperture. Since the first and second aperture drive rings 120 and 121 have the same structure, the gear phases of the first and second ring gears 120b and 121b engaged with the pinion gear 106 and the assembly positional relationship of the respective blade members 104 are the same. Since the first and second aperture drive rings 120 and 121 have the same structure, a rotation amount required for the same light-amount adjusting amount is the same.

In at least one of the first and second aperture drive rings 120 and 121, at least one of the first and second ring gears 120b and 121b is engaged with the pinion gear 106 so that the phase shift of the blade members 104 reduces. Since the first and second aperture drive rings 120 and 121 have the same structure, the use ranges of the first and second ring gears 120b and 121b engaged with the pinion gear 106 during the light amount adjustment are different. This embodiment provides a first drive area that is used for the first aperture drive ring 120 to move from the maximum aperture to a small aperture, and a second drive area that is used for the second aperture drive ring 121 to move from the maximum aperture to a small aperture, which is engaged to match the phase shift of the blade members 104. Thereby, the phase shifts of the respective blade members 104 can be adjusted to a desired state even if the first and second aperture drive rings 120 and 121 have the same structure.

As described above, the configuration according to this embodiment can achieve a natural captured image while a good blur effect is obtained.

### Fourth Embodiment

In the configuration described in the third embodiment, the adjustment angle of the engagement between the pinion gear 106 and the first and second ring gears 120b and 121b can only be adjusted in units of one gear tooth, so the phases of the respective blade members 104 may not match. This embodiment will discuss a configuration for solving this problem. This embodiment will discuss only the configuration that differs from that of the third embodiment, and will omit a description of the common configuration.

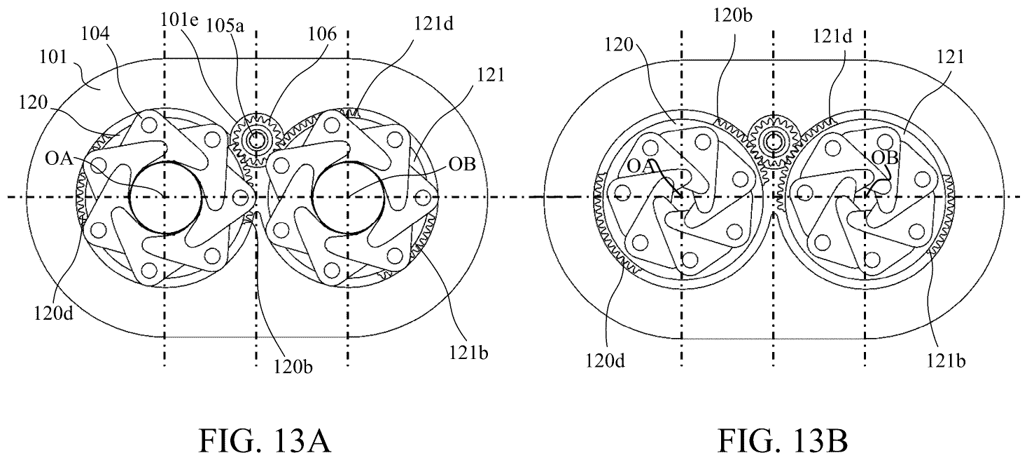

FIGS. 13A and 13B illustrate the configuration of a light-amount adjusting apparatus 100 according to this embodiment. FIG. 13A illustrates the light-amount adjusting apparatus 100 in the maximum aperture state, and FIG. 13B illustrates the light-amount adjusting apparatus 100 in a closed state. The first and second aperture drive rings 120 and 121 have the same structure. The first aperture drive ring 120 is provided with a third ring gear (third transmitter) 120d formed in a different phase in the circumferential direction from that of the first ring gear 120b. The second aperture drive ring 121 is provided with a fourth ring gear (fourth transmitter) 121d formed in a different phase in the circumferential direction from that of the second ring gear 121b. The third and fourth ring gears 120d and 121d are formed in an arrangement such that the phases of the blade members 104 for the respective optical systems are the same in a case where the first and fourth ring gears 120b and 121d are engaged with the pinion gear 106. In one of the first and second aperture drive rings 120 and 121, one of the first and second ring gears 120b and 121b is engaged with the pinion gear 106 so as to reduce the phase shift of the blade members 104. Thereby, the phase shift of the respective blade members 104 can be adjusted to a desired state even if the first and second aperture drive rings 120 and 121 have the same structure.

As described above, the configuration according to this embodiment can achieve a natural captured image while a good blur effect is obtained.

While the disclosure has described example embodiments, it is to be understood that the disclosure is not limited to the example embodiments. The scope of the following claims is to be accorded the broadest interpretation so as to encompass all such modifications and equivalent structures and functions.

The configuration according to each embodiment can achieve a natural captured image while a good blur effect is obtained.

This application claims priority to Japanese Patent Application No. 2024-035996, which was filed on Mar. 8, 2024, and which is hereby incorporated by reference herein in its entirety.

What is claimed is:

1. A light-amount adjusting apparatus configured to adjust a light amount of a first optical system and a light amount of a second optical system, the light-amount adjusting apparatus comprising:
a drive unit configured to drive blade members;
a first opening/closing unit including three or more blade members and configured to open and close at least a part of a first opening through which light is to pass, according to driving of the drive unit; and
a second opening/closing unit including blade members as many as the blade members constituting the first opening/closing unit and configured to open and close at least a part of a second opening through which light is to pass, according to driving of the drive unit,
wherein the first opening/closing unit and the second opening/closing unit are arranged so that in a case where images obtained by imaging using the first optical system and the second optical system are superimposed and all angles between adjacent light striations generated when the light passes through apertures formed by the first opening/closing unit and the second opening/closing unit are equal angles, all the angles between adjacent light striations fall within ±5 degrees.

2. The light-amount adjusting apparatus according to claim 1, wherein the first opening/closing unit and the second opening/closing unit are arranged so that corresponding blade members are in the same phase.

3. The light-amount adjusting apparatus according to claim 1, wherein in a case where the number of the blade members constituting each of the first opening/closing unit and the second opening/closing unit is an odd number, the first opening/closing unit and the second opening/closing unit are arranged so that phases of positions of corresponding blade members are shifted by (360×m)/(the number of the blade members constituting each of the first opening/closing unit and the second opening/closing unit×4) [degrees] (where m is a positive integer).

4. The light-amount adjusting apparatus according to claim 1, wherein in a case where the number of the blade members constituting each of the first opening/closing unit and the second opening/closing unit is an even number, the first opening/closing unit and the second opening/closing unit are arranged so that the phases of the positions of the corresponding blade members are shifted by (360×m)/(the number of the blade members constituting each of the first opening/closing unit and the second opening/closing unit×2) [degrees] (where m is a positive integer).

5. The light-amount adjusting apparatus according to claim 1, further comprising:
a transmission member configured to transmit a drive force from a drive unit,
a first drive member rotatably engaged with the first opening; and
a second drive member rotatably engaged with the second opening,
wherein the first drive member includes a first transmitter configured to receive the drive force via the transmission member and rotate according to the driving of the drive unit,
wherein the second drive member includes a second transmitter configured to receive the drive force via the transmission member and rotate according to the driving of the drive unit,
wherein the blade members constituting the first opening/closing unit are evenly arranged radially around a center of a rotation axis of the first drive member, and
wherein the blade members constituting the second opening/closing unit are evenly arranged radially around a center of a rotation axis of the second drive member.

6. The light-amount adjusting apparatus according to claim 5, wherein a gap that allows the blade members to rotate is formed on an opposite side of the first drive member and the second drive member with respect to the blade members.

7. The light-amount adjusting apparatus according to claim 5, wherein the first drive member and the second drive member have the same structure, and
wherein an area of the first transmitter that is used for rotation of the first drive member is different from an area of the second transmitter that is used for rotation of the second drive member.

8. The light-amount adjusting apparatus according to claim 5, wherein the first drive member further includes a third transmitter provided in a different phase from the first transmitter and configured to receive the drive force via the transmission member,
wherein the second drive member further includes a fourth transmitter provided in a different phase from the second transmitter and configured to receive the drive force via the transmission member,
wherein the first drive member and the second drive members have the same structure, and
wherein the first drive member receives the drive force via the first transmitter and the second drive member receives the drive force via the fourth transmitter.

9. The light-amount adjusting apparatus according to claim 5, further comprising:
a base member holding the drive unit and having the first opening and the second opening; and
a press member fixed to the base member,
wherein the first opening is disposed with a center on an optical axis of the first optical system,
wherein the second opening is disposed with a center on an optical axis of the second optical system,
wherein each of the blade members includes a first engagement portion that serves as a rotation center and a second engagement portion for rotating the blade members,
wherein the first engagement portion is engaged with a hole portion formed in one of a pair of the first drive member and the second drive member, and the press member, and
wherein the second engagement portion is engaged with a cam shape formed in another of the pair of the first drive member and the second drive member, and the press member.

10. The light-amount adjusting apparatus according to claim 9, wherein the light amount of the first optical system is adjusted by adjusting a relative phase between the press member and the first drive member, and by rotating the blade members constituting the first opening/closing unit, and
wherein the light amount of the second optical system is adjusted by adjusting a relative phase between the press member and the second driving member, and by rotating the blade members constituting the second opening/closing unit.

11. The light-amount adjusting apparatus according to claim 1, further comprising:
a base member holding the drive unit and having the first opening and the second opening,
wherein the first opening is disposed with a center on an optical axis of the first optical system, and
wherein the second opening is disposed with a center on an optical axis of the second optical system.

12. A lens apparatus comprising:
a first optical system;
a second optical system; and
a light-amount adjusting apparatus configured to adjust a light amount of the first optical system and a light amount of the second optical system,
wherein the light amount adjusting apparatus includes:
a drive unit configured to drive blade members;
a first opening/closing unit including three or more blade members and configured to open and close at least a part of a first opening through which light is to pass, according to driving of the drive unit; and
a second opening/closing unit including blade members as many as the blade members constituting the first opening/closing unit and configured to open and close at least a part of a second opening through which light is to pass, according to driving of the drive unit,
wherein the first opening/closing unit and the second opening/closing unit are arranged so that in a case where images obtained by imaging using the first optical system and the second optical system are superimposed and all angles between adjacent light striations generated when the light passes through apertures formed by the first opening/closing unit and the second opening/closing unit are equal angles, all the angles between adjacent light striations fall within ±5 degrees.

13. An image pickup apparatus comprising:
a light-amount adjusting apparatus configured to adjust a light amount of a first optical system and a light amount of a second optical system; and
an image sensor configured to photoelectrically convert an optical image formed by at least one of the first optical system and the second optical system,
wherein the light-amount adjusting apparatus includes:
a drive unit configured to drive blade members;
a first opening/closing unit including three or more blade members and configured to open and close at least a part of a first opening through which light is to pass, according to driving of the drive unit; and
a second opening/closing unit including blade members as many as the blade members constituting the first opening/closing unit and configured to open and close at least a part of a second opening through which light is to pass, according to driving of the drive unit,
wherein the first opening/closing unit and the second opening/closing unit are arranged so that in a case where images obtained by imaging using the first optical system and the second optical system are superimposed and all angles between adjacent light striations generated when the light passes through apertures formed by the first opening/closing unit and the second opening/closing unit are equal angles, all the angles between adjacent light striations fall within ±5 degrees.
